(19) United States
(12) Patent Application Publication
(10) Pub. No.: US 2025/0328464 A1
(43) Pub. Date: Oct. 23, 2025

(54) STORAGE DEVICE FOR PERFORMING SELECTIVE FIRMWARE OPERATIONS AND METHOD OF OPERATION

(71) Applicant: SK hynix Inc., Icheon-si (KR)

(72) Inventor: Eun Jae OCK, Icheon-si (KR)

(21) Appl. No.: 18/898,077

(22) Filed: Sep. 26, 2024

(30) Foreign Application Priority Data
Apr. 23, 2024 (KR) 10-2024-0053955

(51) Int. Cl. G06F 12/02; G06F 9/445

(52) U.S. Cl. CPC G06F 12/0246; G06F 9/445

(57) ABSTRACT

A storage device having improved performance may include a memory device a memory device including a plurality of physical positions and a memory controller for performing a plurality of firmware operations on at least one physical position from among the plurality of physical positions, storing position information representing a physical position at which each of the plurality of firmware operation is performed, determining a target physical position at which the firmware operation is successively performed from among the plurality of physical positions based on the position information, and performing the firmware operation at only the target physical position for a predetermined amount of time.

### CROSS-REFERENCE TO RELATED APPLICATION

The present application claims priority under 35 U.S.C. § 119(a) to Korean patent application number 10-2024-0053955 filed on Apr. 23, 2024, in the Korean Intellectual Property Office, the entire disclosure of which is incorporated by reference herein.

### BACKGROUND

### 1. Technical Field

The present disclosure generally relates to a semiconductor device, and more particularly, to a storage device and a method of operating the storage device.

### 2. Related Art

A storage device is a device that stores data under the control of a host device, including a computer, a mobile terminal such as a smartphone or a tablet, and various electronic devices. The storage device may include a memory device that stores data and a memory controller that controls the memory device.

The storage device may reduce, through a firmware operation, a problem, a defect, an error, or the like, which may occur according to a physical position within the memory device in an operation of the memory device. The firmware operation may be designated as a work around operation.

### SUMMARY

Embodiments provide a storage capable of selectively performing a firmware operation, based on a physical characteristic corresponding to a physical position within a memory device, and a method of operating the storage device.

In accordance with an aspect of the present disclosure, there is provided a storage device including: a memory device including a plurality of physical positions; and a memory controller configured to perform a plurality of firmware operations on at least one physical position among the plurality of physical positions, store position information representing a physical position at which each of the plurality of firmware operations is performed, determine a target physical position at which the firmware operation is successively performed from among the plurality of physical positions, based on the position information, and perform the firmware operation at only the target physical position among the plurality of physical positions for a predetermined time period.

In accordance with another aspect of the present disclosure, there is provided a storage device including: a memory device including a plurality of physical positions; and a memory controller configured to perform a plurality of firmware operations on at least one physical position from among the plurality of physical positions, store position information representing a physical position at which each of the plurality of firmware operation is performed, count a number of times the plurality of firmware operations are performed on the physical position, and determine a target physical position at which the firmware operation is to be performed from among the plurality of physical positions, based on the position information, when a number of times the firmware operation is performed reaches a predetermined number of times.

In accordance with still another aspect of the present disclosure, there is provided a method of operating a storage device, the method including: performing a plurality of firmware operations on a memory device; counting a number of times each of the plurality of firmware operations is performed; storing position information representing at least one physical position at which each of the plurality of firmware operations is performed from among a plurality of physical positions included in the memory device; and determining a target physical position at which each of the plurality of firmware operations is to be performed from among the plurality of physical positions based on the number of times each of the plurality of firmware operations is performed and the position information.

### BRIEF DESCRIPTION OF THE DRAWINGS

Example embodiments will now be described more fully hereinafter with reference to the accompanying drawings; however, the inventions may be embodied in different forms and should not be construed as limited to the embodiments set forth herein. Rather, these embodiments are provided so that this disclosure will be thorough and complete, and will fully convey the scope of the example embodiments to those skilled in the art.

In the drawings, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a storage device in accordance with an embodiment of the present disclosure.

FIG. 2 is a diagram illustrating an example of a plurality of physical positions in accordance with an embodiment of the present disclosure.

FIG. 3 is a diagram illustrating another example of a plurality of physical positions in accordance with an embodiment of the present disclosure.

FIG. 4 is a diagram illustrating an example of performing a firmware operation in accordance with an embodiment of the present disclosure.

FIG. 5 is a diagram illustrating runtime information in accordance with an embodiment of the present disclosure.

FIG. 6 is a diagram illustrating an example of determining a target physical position at which a firmware operation is to be performed in accordance with an embodiment of the present disclosure.

FIG. 7 is a diagram illustrating another example of determining a target physical position at which a firmware operation is to be performed in accordance with an embodiment of the present disclosure.

FIG. 8 is a flowchart illustrating an operating method of a storage device in accordance with an embodiment of the present disclosure.

FIG. 9 is a flowchart illustrating an example of a method of determining a target physical position in accordance with an embodiment of the present disclosure.

FIG. 10 is a flowchart illustrating another example of a method of determining a target physical position in accordance with an embodiment of the present disclosure.

FIG. 11 is a diagram illustrating a memory controller in accordance with an embodiment of the present disclosure.

### DETAILED DESCRIPTION

The specific structural or functional description disclosed herein is merely illustrative for the purpose of describing embodiments according to the concepts of the present disclosure. The embodiments according to the concepts of the present disclosure can be implemented in various forms, and cannot be construed as limited to the embodiments set forth herein.

In flowcharts or flow diagrams, which are shown in this specification, identification codes in each step are used to identify the step and do not describe the order of the steps, and each step may be performed differently from the stated order unless explicitly stated in the context. Also, in the flowcharts or flow diagrams, which are shown in this specification, a method is described by being divided into a plurality of steps, but at least one step of the method may be performed by changing the order, performed by being combined with another steps, omitted, performed by being divided into sub-steps, or performed by adding one or more steps which are not shown.

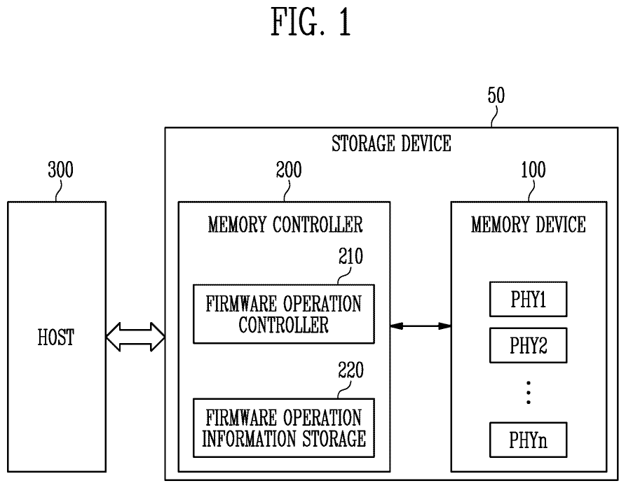

FIG. 1 is a diagram illustrating a storage device in accordance with an embodiment of the present disclosure.

Referring to FIG. 1, a storage device 50 may be a device for storing data under the control of a host 300, examples of which include a mobile phone, a smartphone, an MP3 player, a laptop computer, a server computer, a desktop computer, a game console, a TV, a tablet PC or an in-vehicle infotainment.

The storage device 50 may include a memory device 100 and a memory controller 200.

The storage device 50 may be configured as any one of various storage devices, such as an SSD, a multimedia card in the form of an MMC or an eMMC, a Universal Serial Bus (USB) storage device, a Universal Flash Storage (UFS) device, a peripheral component interconnection (PCI) card type storage device, a PCI express (PCI-E) card type storage device, a Compact Flash (CF) card, a Smart Media Card (SMC), and a memory stick, according to a communication scheme with the host 300.

The storage device 50 may be manufactured as any one of various kinds of package types. For example, the storage device 50 may be manufactured as any one of various kinds of package types such as a Package-On-Package (POP), a System-In-Package (SIP), a System-On-Chip (SOC), a Multi-Chip Package (MCP), a Chip-On-Board (COB), a Wafer-level Fabricated Package (WFP), and a Wafer-level Stack Package (WSP).

The memory device 100 may store data. The memory device 100 may include a plurality of memory blocks for storing data. Each memory block may include a plurality of memory cells.

In an embodiment, the memory device 100 may be a nonvolatile memory in which data does not disappear even when the supply of power is interrupted. In this specification, for convenience of description, the memory device 100 is assumed to be a NAND flash memory is described as such.

In an embodiment, the memory device 100 may receive a command and an address from the memory controller 200. The memory device 100 may perform an operation indicated by the command on an area selected by the address. For example, the memory device 100 may perform a write operation (or program operation), a read operation, and an erase operation.

In an embodiment, the memory device 100 may include a plurality of physical positions PHY1 to PHYn. The plurality of physical positions PHY1 to PHYn may indicate positions of a plurality of physical components, a plurality of physical devices, a plurality of physical areas, structures or the like, which are included in the memory device 100.

The memory controller 200 may control overall operations of the storage device 50.

When power is applied to the storage device 50, the memory controller 200 may execute firmware (FW). Although not illustrated, when the memory device 100 is a flash memory device, the FW may include a Host Interface Layer (HIL) for controlling communication with the host 300, a Flash Translation Layer (FTL) for controlling communication between the host 300 and the memory device 100, and a Flash Interface Layer (FIL) for controlling communication with the memory device 100.

In an embodiment, the memory controller 200 may receive data and a Logical Block Address (LBA) from the host 300, and translate the LBA into a Physical Block Address (PBA) representing addresses of memory cells included in the memory device 100, in which data is to be stored. In this specification, the LBA and a “logic address” or “logical address” may be used with the same meaning. In this specification, the PBA and a “physical address” may be used with the same meaning.

In an embodiment, the memory controller 200 may provide the memory device 100 with a command, an address or data, which corresponds to a program operation, a read operation, an erase operation or the like, to perform the corresponding operation according to a request of the host 300.

In an embodiment, the memory controller 200 may autonomously generate a command, an address, and data, regardless of any request from the host 300, and transmit the command, the address, and the data to the memory device 100. For example, the memory controller 200 may provide the memory device 100 with a command, an address, and data, which are used to perform program and read operations accompanied in performing internal operations such as a wear leveling operation, a read reclaim operation, a garbage collection operation, and the like.

In an embodiment, the memory controller 200 may include a firmware operation controller 210 and a firmware operation information storage 220.

The firmware operation controller 210 may control a firmware operation performed in the memory device 100.

In an embodiment, the firmware operation may be an operation for reducing or bypassing a problem, a defect, an error, or the like, which may occur according to a physical characteristic corresponding to a physical position within the memory device 100 when a program operation, a read operation, an erase operation or the like is performed in the memory device 100.

In an embodiment, the firmware operation may be performed according to a physical characteristic corresponding to each of the plurality of physical positions PHY1 to PHYn in an operation of the memory device 100. For example, the firmware operation controller 210 may check whether an occurrence condition of the firmware operation is satisfied with respect to each of the plurality of physical positions PHY1 to PHYn. When the occurrence condition of the firmware operation is satisfied at a specific physical position, the firmware operation controller 210 may perform the firmware operation at the corresponding physical position in the operation of the memory device 100.

In an embodiment, the firmware operation controller 210 may control a plurality of different kinds of firmware operations.

The firmware operation information storage 220 may store information related to the firmware operation. For example, the firmware operation information storage 220 may store a number of times each of the plurality of firmware operations are performed and position information representing a physical position at which each of the plurality of firmware operations is performed.

In an embodiment, the firmware operation controller 210 may determine a target physical position at which each of the plurality of firmware operations is to be performed among the plurality of physical positions PHY1 to PHYn, based on the number of times each of the plurality of firmware operations is performed and the position information.

In an embodiment, the firmware operation controller 210 may perform each of the plurality of firmware operations at the target physical position for each of the plurality of firmware operations for a predetermined amount of time.

The host 300 may communicate with the storage device 50, using at least one of various communication manners, such as a Universal Serial bus (USB), a Serial AT Attachment (SATA), a High Speed InterChip (HSIC), a Small Computer System Interface (SCSI), Firewire, a Peripheral Component Interconnection (PCI), a PCI express (PCIe), a Non-Volatile Memory express (NVMe), a universal flash storage (UFS), a Secure Digital (SD), a Multi-Media Card (MMC), an embedded MMC (eMMC), a Dual In-line Memory Module (DIMM), a Registered DIMM (RDIMM), and a Load Reduced DIMM (LRDIMM).

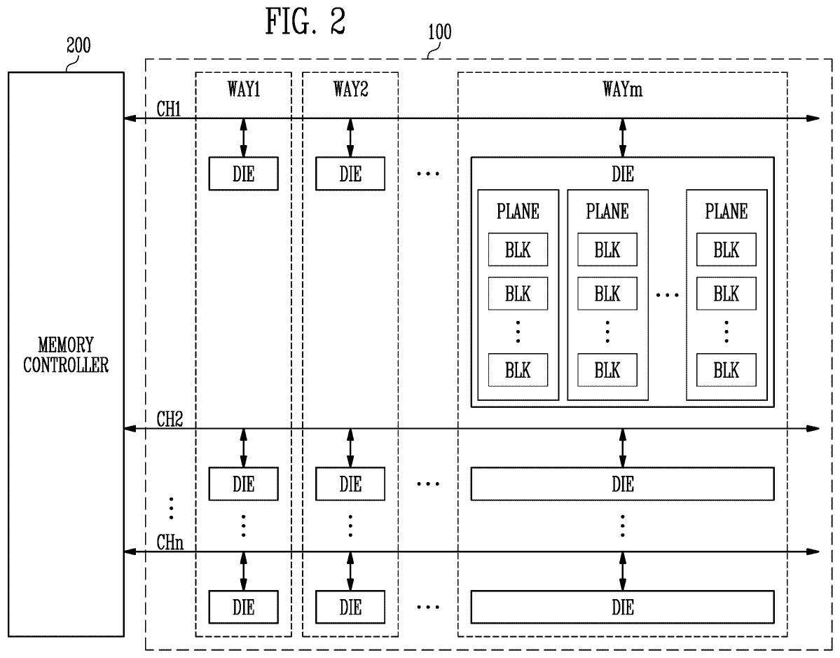

FIG. 2 is a diagram illustrating an example of a plurality of physical positions in accordance with an embodiment of the present disclosure.

Referring to FIG. 2, a memory device 100 may include a plurality of dies DIE. In an embodiment, each of the plurality of dies DIE may include a plurality of planes PLANE. Each of the plurality of planes PLANE may include a plurality of memory blocks BLK.

In an embodiment, the performance of the memory device 100 including the plurality of dies DIE may be improved using an interleaving scheme. The interleaving scheme may be a scheme for controlling at least two memory dies DIE to overlap with each other in operations. For the interleaving scheme, the plurality of dies DIE may be managed in units of channels and ways.

For example, a plurality of dies DIE may be connected to any one channel from among a plurality of channels CH1 to CHn. Each of the channels CH1 to CHn may be a bus for signals that memory dies DIE connected to the corresponding channel share and use. A plurality of dies DIE may be included in any way among a plurality of ways WAY1 to WAYm. For example, a memory controller 200 may transmit a command, an address, and the like to a die DIE included in a first way WAY1 through the first channel CH1. While the corresponding die DIE in the first way WAY1 performs an operation according to the command, the memory controller 200 may transmit a command, an address, and the like to a die DIE included in a second way WAY2 through the first channel CH1.

FIG. 2 illustrates each way formed with die DIE units. However, the present disclosure is not necessarily limited thereto. For example, each way may be configured with plane PLANE units or memory block BLK units, or combinations of all of the above.

In an embodiment, the die DIE, the plane PLANE, the memory block BLK, each of the channels CH1 to CHn, or each of the ways WAY1 to WAYm may correspond to a physical component, a physical device or a physical area in the memory device 100. Therefore, a physical position can be a position that indicates or locates the die DIE, a plane PLANE, the memory block BLK, each of the channels CH1 to CHn, or each of the ways WAY1 to WAYm.

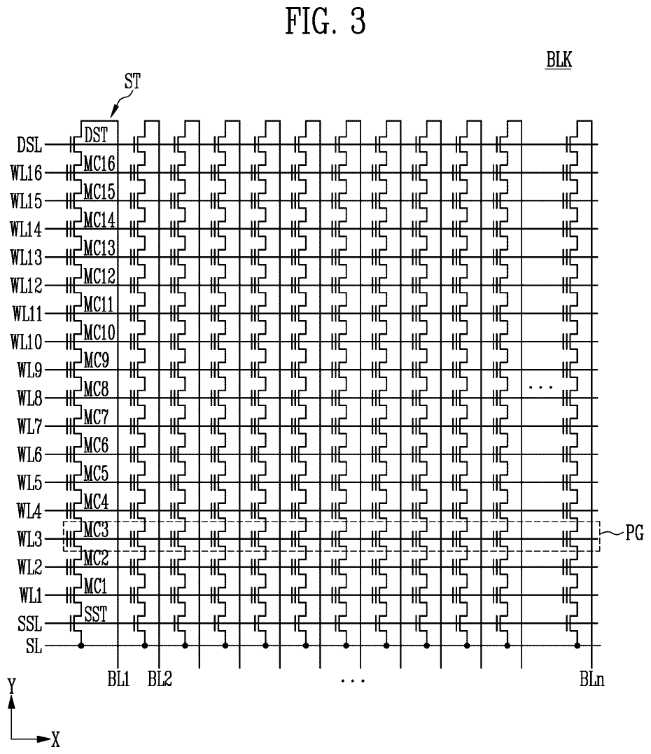

FIG. 3 is a diagram illustrating another example of a plurality of physical positions in accordance with an embodiment of the present disclosure. A memory block BLK may represent any one of the memory blocks BLK shown in FIG. 2.

Referring to FIG. 3, a plurality of word lines arranged in parallel to each other may be connected between a first select line and a second select line. The first select line may be a source select line SSL, and the second select line may be a drain select line DSL. More specifically, the memory block BLK may include a plurality of strings ST connected between bit lines BL1 to BLn and a source line SL. The bit lines BL1 to BLn may be respectively connected to the strings ST, and the source line SL may be commonly connected to the strings ST. The strings ST may be configured identically to one another, and therefore, a string ST connected to a first bit line BL1 will be described in detail as an example.

The string ST may include a source select transistor SST, a plurality of memory cells MC1 to MC16, and a drain select transistor DST, which are connected in series to each other between a source line SL and a first bit line BL1. At least one source select transistor SST and at least one drain select transistor DST may be included in one string ST. While FIG. 3 illustrates sixteen memory cells MC1 to MC16, the number of memory cells are not limited and in other embodiments, more cells than shown in FIG. 3 may be included in one string ST.

A source of the source select transistor SST may be connected to the source line SL, and a drain of the drain select transistor DST may be connected to the first bit line BL1. The memory cells MC1 to MC16 may be connected in series between the source select transistor SST and the drain select transistor DST. Gates of source select transistors SST included in different strings ST may be connected to the source select line SSL, and gates of drain select transistors DST included in different strings ST may be connected to the drain select line DSL. Gates of the memory cells MC1 to MC16 may be connected to a plurality of word lines WL1 to WL16. A group of memory cells connected to the same word line but included in different strings ST may be referred to as a physical page PPG.

One memory cell may store data of one bit. This memory cell is generally called a single level cell (SLC). In this case, one physical page PG may store one logical page (LPG) data. One logical page (LPG) data may include data bits corresponding to the number of cells included in one physical page PG.

In an embodiment, one memory cell may store data of two or more bits. In this case, one physical page PG may store two or more logical page (LPG) data.

In an embodiment, the string ST, the source select line SSL, the drain select line DSL, the source select transistor SST, the drain select transistor DST, the source line SL, each of the word lines WL1 to WL16, each of the bit lines BL1 to BLn, the page PG, or each of the memory cells MC1 to MC16 may correspond to a physical component, a physical device or a physical area in a memory device 100. Therefore, a physical position may include a position indicating the string ST, the source select line SSL, the drain select line DSL, the source select transistor SST, the drain select transistor DST, the source line SL, each of the word lines WL1 to WL16, each of the bit lines BL1 to BLn, the page PG, or each of the memory cells MC1 to MC16.

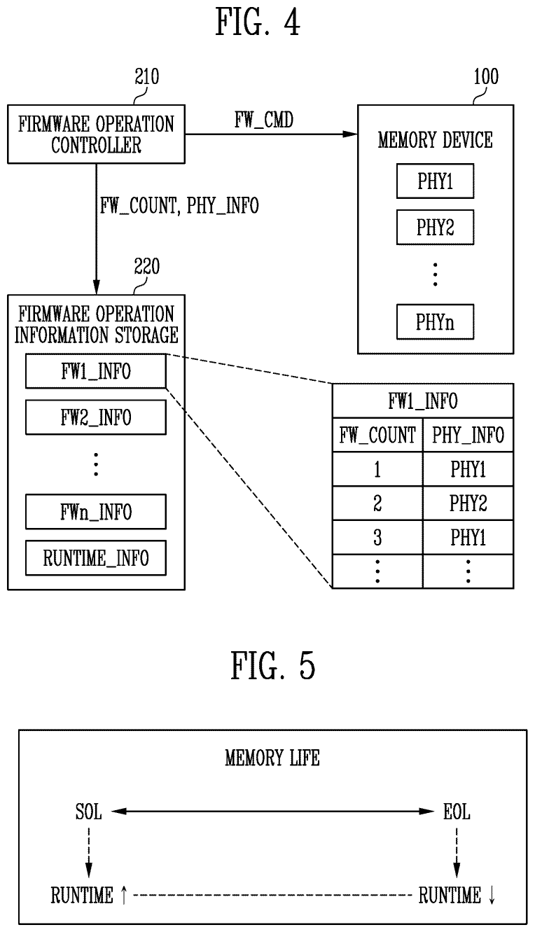

FIG. 4 is a diagram illustrating an example of performing a firmware operation in accordance with an embodiment of the present disclosure.

Referring to FIG. 4, among a plurality of physical positions PHY1 to PHYn, a firmware operation controller 210 may check a physical position to determine if a condition is met that requires a firmware operation. The firmware operation may occur based on a physical characteristic corresponding to each of the plurality of physical positions PHY1 to PHYn in an operation of a memory device 100. An occurrence condition that requires a firmware operation may vary according to the kind of each firmware operation. The firmware operation controller 210 may check whether the occurrence condition of a firmware operation is satisfied at each of the plurality of physical positions PHY1 to PHYn.

In an embodiment, when the occurrence condition of the firmware operation is checked and satisfied by a physical position, the firmware operation controller 210 may transmit, to the memory device 100, a command FW_CMD indicating the firmware operation and information on the physical position satisfying the occurrence condition of the firmware operation.

In an embodiment, a firmware operation information storage 220 may store firmware operation information FW1_INFO to FWn_INFO on a plurality of firmware operations. Each of the firmware operation information FW1_INFO to FWn_INFO may include a number of times FW_COUNT that each firmware operation is performed and position information PHY_INFO. In FIG. 4, for convenience of description, firmware operation information FW1_INFO for a first firmware operation, among the plurality of firmware operations, will be described as an example.

In an embodiment, the firmware operation controller 210 may count a number of times FW_COUNT that each firmware operation is performed. For example, the firmware operation controller 210 may perform a plurality of first firmware operations on at least one physical position. The firmware operation controller 210 may count a number of times FW_COUNT that the first firmware operation is performed, and provide the firmware operation information storage 220 with the number of times FW_COUNT the first firmware operation is performed.

In an embodiment, the firmware operation information storage 220 may store position information PHY_INFO representing a physical position at which each of the plurality of firmware operations is performed. For example, the firmware operation controller 210 may provide the firmware operation information storage 220 with position information PHY_INFO representing a physical position at which the first firmware operation is performed each time the first firmware operation is performed. The position information PHY_INFO may include information about the order the first firmware operation has been performed on which physical positions. For example, PHY_INFO in FW1_INFO includes information representing that the first firmware operation first occurred at a first physical position PHY1, information representing that the first firmware operation has been secondly performed at a second physical position PHY2, and information representing that the first firmware operation has been thirdly performed at the first physical position PHY1.

In an embodiment, the firmware operation information storage 220 may store runtime information RUNTIME_INFO representing a predetermined time, i.e., the amount of time or time period in which the firmware operation is performed at a target physical position. For example, when a target physical position for the firmware operation is determined, the firmware operation controller 210 may perform the firmware operation at the target physical position for the predetermined amount of time, based on the runtime information RUNTIME_INFO stored in the firmware operation information storage 220.

In an embodiment, the firmware operation controller 210 may determine a target physical position at which the firmware operation is to be performed for the predetermined time period, based on the number of times FW_COUNT the first firmware operation is performed and the position information PHY_INFO. For example, after a plurality of firmware operations are performed on at least one physical position satisfying the occurrence condition of the firmware operation, the firmware operation controller 210 may determine a target physical position, based on the number of times FW_COUNT the first firmware operation is performed and the position information PHY_INFO. The firmware operation controller 210 may perform the firmware operation at the target physical position for the predetermined amount of time.

As the frequency of firmware operations increases, the performance of a storage device 50 may deteriorated. In addition, for a general firmware operation, the occurrence condition can be checked at all the physical positions PHY1 to PHYn to determine whether the condition is satisfied. As the frequency of checking operations increases, the performance of the storage device 50 may deteriorated. Thus, in accordance with embodiments of the present disclosure, a target physical position is determined based on the number of times a firmware operation is performed and information on the physical position at which the firmware operation is performed. Using this information, the firmware operation is performed at the target physical position for the predetermined time period, so that the performance of the storage device 50 can be improved.

FIG. 5 is a diagram illustrating runtime information in accordance with an embodiment of the present disclosure.

Referring to FIG. 5, an amount of time RUNTIME for which the firmware operation is performed at the target physical position may decrease as the lifetime MEMORY LIFE of a memory device 100 is reduced.

For example, at a Start of Life (SOL) of the lifetime MEMORY LIFE of the memory device 100, the probability that a problem, a defect, an error, or the like according to a physical characteristic corresponding to a physical position will occur in an operation of the memory device 100 may be low. The time RUNTIME during which the firmware operation is performed at the target physical position may be highest at the SOL. After that, when the lifetime MEMORY LIFE of the memory device 100 enters into an End of Life (EOL), the probability that the problem, the defect, the error or the like according to the physical characteristic will occur in the operation of the memory device 100 may become high. The time RUNTIME during which the firmware operation is performed at the target physical position may be decreased as the memory device approaches the EOL.

In FIG. 5, the time RUNTIME during which the firmware operation is performed at the target physical position changes according to the lifetime MEMORY LIFE of the memory device 100. However, the present disclosure is not necessarily limited thereto. For example, the time RUNTIME during which the firmware operation is performed at the target physical position may be increased or decreased according to indexes such as abrasion, performance, and reliability.

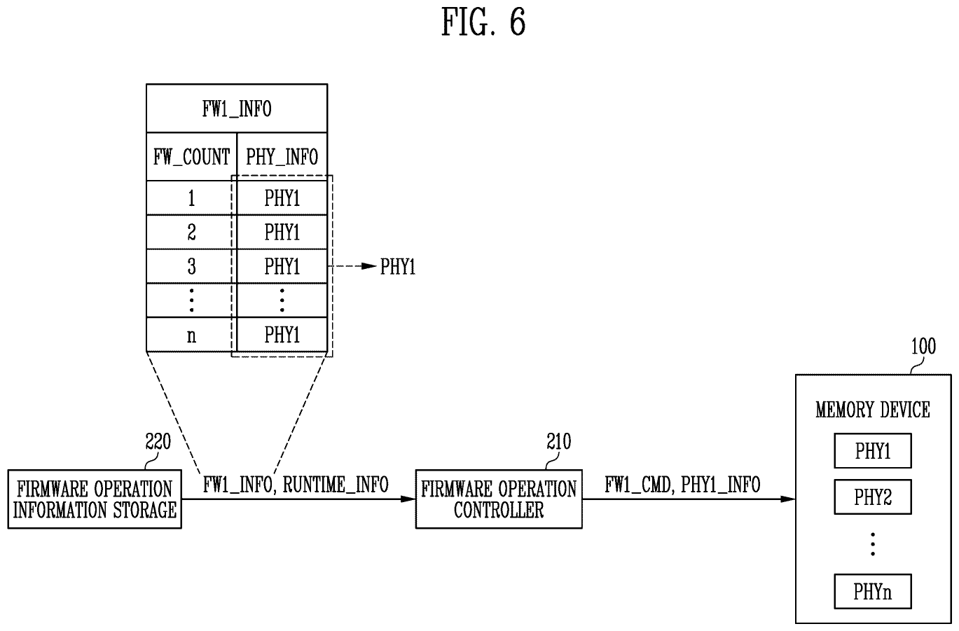

FIG. 6 is a diagram illustrating an example of determining a target physical position at which a firmware operation is to be performed in accordance with an embodiment of the present disclosure. In FIG. 6, for convenience of description, an example of determining a target physical position at which the first firmware operation, from among the plurality of firmware operations, is to be performed.

Referring to FIG. 6, a firmware operation controller 210 may determine a target physical position at which the firmware operation is successively performed, from among the plurality of physical positions PHY1 to PHYn, based on the position information PHY_INFO.

In an embodiment, at the target physical position, a number of times that the firmware operation is successively performed may exceed a predetermined first number of times. For example, the firmware operation controller 210 may acquire firmware operation information FW1_INFO on the first firmware operation from a firmware operation information storage 220. FIG. 6 illustrates a first number of times as an n number of times as an example. When an n number of first firmware operations are all performed at the first physical position PHY1, the firmware operation controller 210 may determine the first physical position PHY1 as the target physical position.

In an embodiment, the predetermined first number of times may be decreased as the lifetime of the memory device 100 is reduced. For example, the first number of times may be highest at the SOL of the lifetime of the memory device 100, and decrease approaching the EOL of the lifetime of the memory device 100. However, the present disclosure is not necessarily limited thereto, and the first number of times may be increased or decreased according to indexes such as abrasion, performance, and reliability.

In an embodiment, the firmware operation controller 210 may perform the firmware operation at the target physical position for a predetermined amount of time. For example, the firmware operation controller 210 may acquire runtime information RUNTIME_INFO from the firmware operation information storage 220. The firmware operation controller 210 may provide the memory device 100 with a command FW1_CMD indicating the first firmware operation to be performed at the first physical position PHY1 for a time set according to the runtime information RUNTIME_INFO, and information PHY1_INFO on the first physical position PHY1.

In an embodiment, the firmware operation controller 210 may omit the firmware operation at the other physical positions, except the target physical position among the plurality of physical positions, for the predetermined time period. For example, the firmware operation controller 210 may omit the first firmware operation at the other physical positions PHY2 to PHYn, but not at the first physical position PHY1.

Accordingly, the memory device 100 may perform the first firmware operation at the first physical position PHY1 for the predetermined time period in response to the command FW1_CMD, and omit the first firmware operation at the other physical positions PHY2 to PHYn.

In an embodiment, after the predetermined time period elapses, the firmware operation controller 210 may perform the firmware operation at a physical position, among the plurality of physical positions, that satisfies an occurrence condition of the firmware operation. For example, when the predetermined time elapses, the firmware operation controller 210 may check whether the physical position satisfies an occurrence condition of the first firmware operation not only with respect to the first physical position PHY1, but also with respect to the other physical positions PHY2 to PHYn. The firmware operation controller 210 may perform the first firmware operation at the physical position satisfying the occurrence condition of the firmware operation according to results from the check.

In an embodiment, the firmware operation controller 210 may re-determine a target physical position, based on the firmware operation performed after the predetermined amount of time elapses. For example, the firmware operation controller 210 may re-accumulate information on the first firmware operation performed after the predetermined time period elapses. That is, after the predetermined time period elapses, the firmware operation controller 210 may re-count a number of times FW_COUNT the first firmware operation is performed, and the firmware operation information storage 220 may re-store position information PHY_INFO representing a physical position at which the first firmware operation is performed. The firmware operation controller 210 may re-determine the target physical position, based on the number of times FW_COUNT the first firmware operation is performed and the position information PHY_INFO.

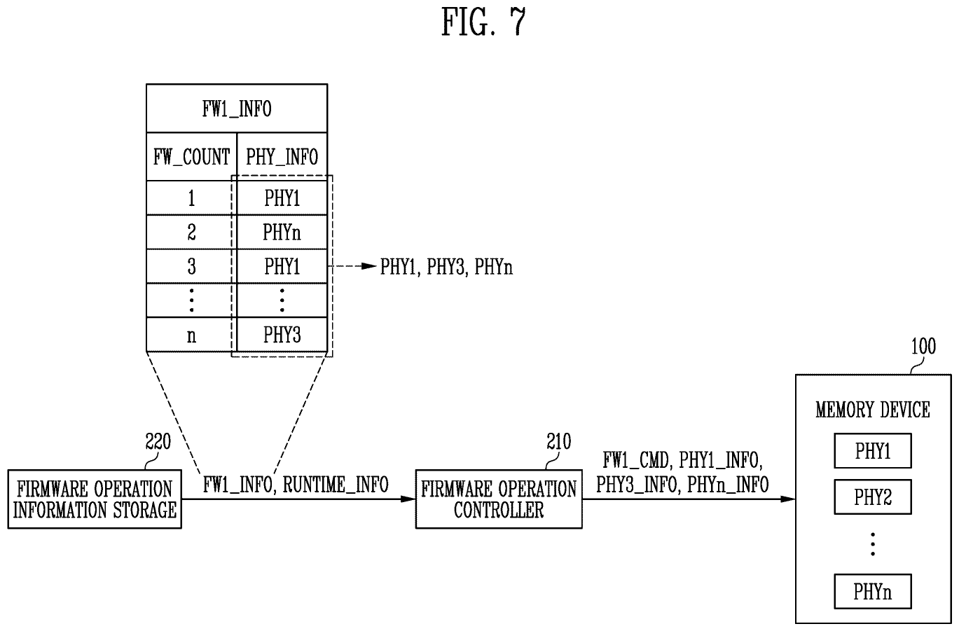

FIG. 7 is a diagram illustrating another example of determining a target physical position at which a firmware operation is to be performed in accordance with an embodiment of the present disclosure. For convenience of description, FIG. 7 illustrates an example of determining a target physical position at which a first firmware operation, from among the plurality of firmware operations, is to be performed.

Referring to FIG. 7, when the number of times the firmware operation is performed reaches a predetermined second number of times, a firmware operation controller 210 may determine a target physical position at which the firmware operation is to be performed based on the position information PHY_INFO. For example, the firmware operation controller 210 may acquire firmware operation information FW1_INFO on the first firmware operation from a firmware operation information storage 220. FIG. 7 illustrates an example where the second number of times is an n number of times. When the number of times the first firmware operation is performed reaches an n number of times, the firmware operation controller 210 may determine a target physical position, based on the position information PHY_INFO representing a physical position at which each of n first firmware operations is performed.

In an embodiment, the predetermined second number of times may be decreased as the lifetime of the memory device 100 is reduced. For example, the second number of times may be highest at the SOL of the lifetime of a memory device 100, and may decrease while approaching the EOL of the lifetime of a memory device 100. However, the present disclosure is not necessarily limited thereto, and the second number of times may be increased or decreased according to indexes such as abrasion, performance, and reliability.

In an embodiment, when the number of times the firmware operation is performed reaches the second number of times, the firmware operation controller 210 may determine, as the target physical position, a physical position at which each of a plurality of firmware operations is performed. For example, when the first firmware operation is performed at the first physical position PHY1, a third physical position PHY3, and an nth physical position PHYn while the n first firmware operations are performed, the firmware operation controller 210 may determine, as the target physical position, the first physical position PHY1, the third physical position PHY3, and the nth physical position PHYn.

In an embodiment, the firmware operation controller 210 may perform the firmware operation at the target physical position for a predetermined amount of time. For example, the firmware operation controller 210 may acquire runtime information RUNTIME_INFO from the firmware operation information storage 220. The firmware operation controller 210 may provide the memory device 100 with a command FW1_CMD indicating the first firmware operation to be performed at the first physical position PHY1, the third physical position PHY3, and the nth physical position PHYn for a time period set according to the runtime information RUNTIME_INFO and information PHY1_INFO, PHY3_INFO, and PHYn_INFO on the first physical position PHY1, the third physical position PHY3, and the nth physical position PHYn.

In an embodiment, the firmware operation controller 210 may omit, for the predetermined time period, the firmware operation at the other physical positions other than the target physical position from among the plurality of physical positions. For example, the firmware operation controller 210 may omit the first firmware operation at the other physical positions PHY2 and PHY4 to PHYn−1, but not the first physical position PHY1, the third physical position PHY3, and the nth physical position PHYn.

Accordingly, the memory device 100 may perform the first firmware operation at the first physical position PHY1, the third physical position PHY3, and the nth physical position PHYn for the predetermined amount of time in response to the command FW1_CMD, and omit the first firmware operation at the other physical positions PHY2 and PHY4 to PHYn−1.

In an embodiment, when the number of times the firmware operation is performed does not reach the second number of times, the firmware operation controller 210 may perform the firmware operation at a physical position satisfying an occurrence condition of the firmware operation from among the plurality of physical positions. For example, when the number of times the first firmware operation is performed does not reach the second number, the firmware operation controller 210 may check whether the physical position satisfies an occurrence condition of the first firmware operation at the plurality of physical positions PHY1 to PHYn. The firmware operation controller 210 may perform the first firmware operation at the physical position satisfying the occurrence condition of the firmware operation according to the results of the checks.

In an embodiment, when the first firmware operation is re-performed an n number of times after the predetermined time elapses, the firmware operation controller 210 may re-determine, as the target physical position, at least one physical position at which the first firmware operation is performed while n first firmware operations are re-performed for the predetermined time.

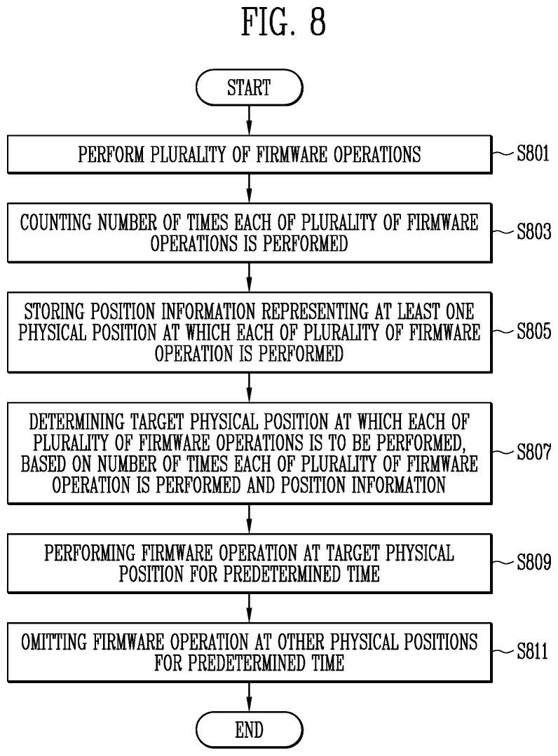

FIG. 8 is a flowchart illustrating an operating method of a storage device in accordance with an embodiment of the present disclosure. The operating method shown in FIG. 8 may be performed by a storage device 50 shown in FIG. 1.

Referring to FIG. 8, in step S801, the storage device 50 may perform a plurality of firmware operations on a memory device 100.

In step S803, the storage device 50 may count a number of times each of the plurality of firmware operations is performed.

In step S805, the storage device 50 may store position information representing at least one physical position at which each of the plurality of firmware operation is performed, from among a plurality of physical positions included in the memory device 100.

In step S807, the storage device 50 may determine a target physical position at which each of the plurality of firmware operations is to be performed, from among the plurality of physical positions, based the number of times each of the plurality of firmware operations is performed and the position information.

In step S809, the storage device 50 may perform any one firmware operation, from among the plurality of firmware operations, at the target physical position corresponding to the one firmware operation for a predetermined time period.

In step S811, for the predetermined time period, the storage device 50 may omit the one firmware operation at the other physical positions other than the target physical position, from among the plurality of physical positions.

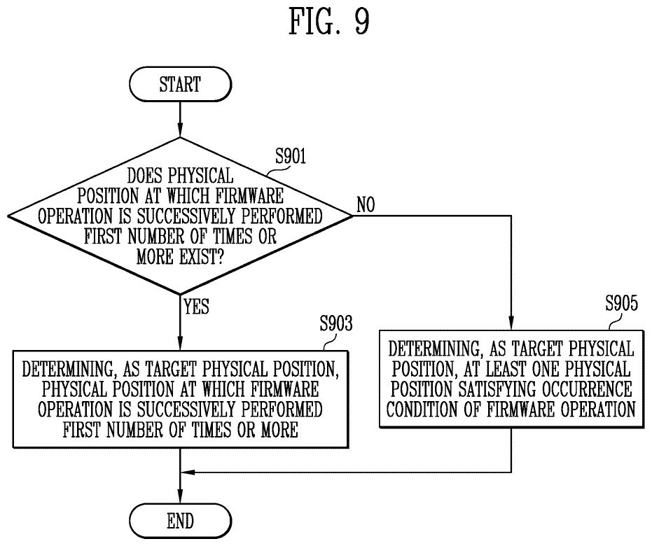

FIG. 9 is a flowchart illustrating an example of a method of determining a target physical position in accordance with an embodiment of the present disclosure. The method shown in FIG. 9 may be performed by a storage device 50 shown in FIG. 1.

Referring to FIG. 9, the storage device 50 may determine, as a target physical position, the position at which the one firmware operation is to be performed, which is a physical position at which any one firmware operation, from among a plurality of firmware operations, is successively performed for a first number of times or more.

For example, in step S901, the storage device 50 may determine whether a physical position at which a firmware operation is successively performed, for the first number of times or more, exists based on position information.

According to a determination result in the step S901, when the physical position exists at which the firmware operation is successively performed for the first number of times or more, the storage device 50 may perform step S903. In the step S903, the storage device 50 may determine, as a target physical position, the physical position at which the firmware operation is successively performed for the first number of times or more.

Alternatively, according to a determination result in the step S901, when the physical position at which the firmware operation is successively performed for the first number of times or more does not exist, the storage device 50 may perform step S905. In the step S905, the storage device 50 may determine, as the target physical position, at least one physical position satisfying an occurrence condition of the firmware operation.

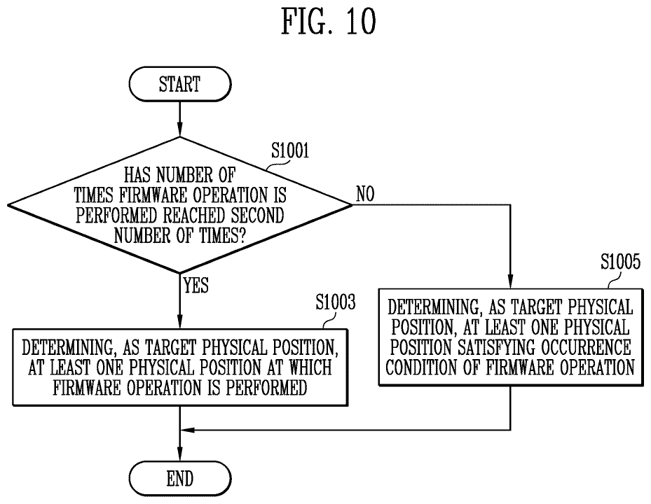

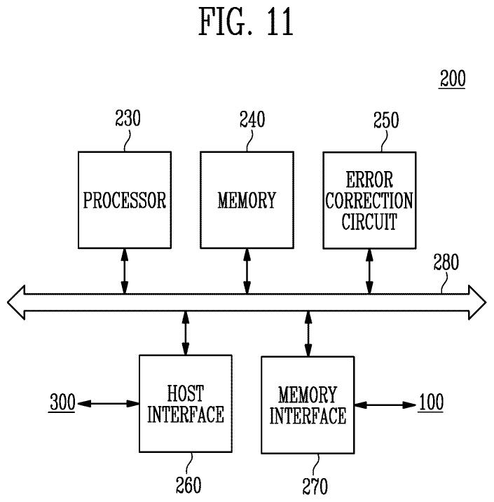

FIG. 10 is a flowchart illustrating another example of a method of determining a target physical position in accordance with an embodiment of the present disclosure. The method shown in FIG. 10 may be performed by a storage device 50 shown in FIG. 1.

Referring to FIG. 10, the storage device 50 may determine, as a target physical position, at least one physical position at which any one firmware operation, from among a plurality of firmware operations, is performed when the number of times that the one firmware operation is performed reaches a second number of times.

For example, in step S1001, the storage device 50 may determine whether a number of times a firmware operation is performed has reached the second number of times, based on position information.

According to a determination result in the step S1001, when the number of times the firmware operation is performed reaches the second number of times, the storage device 50 may perform step S1003. In the step S1003, the storage device 50 may determine, as a target physical position, at least one physical position at which the firmware operation is performed.

Alternatively, according to a determination result in the step S1001, when the number of times the firmware operation is performed does not reach the second number of times, the storage device 50 may perform step S1005. In the step S1005, the storage device 50 may determine, as the target physical position, at least one physical position satisfying an occurrence condition of the firmware operation.

FIG. 11 is a diagram illustrating a memory controller in accordance with an embodiment of the present disclosure.

Referring to FIG. 11, a memory controller 200 may include a processor 230, a memory 240, an error correction circuit 250, a host interface 260, a memory interface 270, and a communication bus 280. The processor 230, the memory 240, the error correction circuit 250, the host interface 260, and the memory interface 270 may communicate with each other through the communication bus 280.

The processor 230 may execute firmware, a code, or one or more commands, including various information required when the memory controller 200 operates. In an embodiment, the firmware operation controller 210 shown in FIG. 1 may be implemented with at least one component stored in the processor 230.

The memory 240 may be used as a buffer memory, a cache memory, a working memory, or the like. In an embodiment, a firmware operation information storage 220 shown in FIG. 1 may be implemented with at least one component included in the memory 240.

Also, the memory 240 may store firmware, a code, or one or more commands, including various information required when the memory controller 200 operates.

The error correction circuit 250 may perform error correction when data is stored in a memory device 100 or when data is read from the memory device 100. For example, the error correction circuit 250 may perform Error Correction Code (ECC) encoding, based on data to be written to the memory device 100. The encoded data may be transferred to the memory device 100. The error correction circuit 250 may perform ECC decoding on data received from the memory device 100.

The memory controller 200 may communicate with an external device (e.g., a host 300, an application processor, or the like) through the host interface 260.

The memory controller 200 may communicate with the memory device 100 through the memory interface 270. The memory controller 200 may transmit a command, an address, a control signal, and the like to the memory device 100 through the memory interface 270, and receive data from the memory device 100 through the memory interface 270.

In accordance with the present disclosure, there can be provided a storage device having improved performance by selectively performing firmware operations, and a method of operating the storage device.

While the present disclosure has been shown and described with reference to certain exemplary embodiments thereof, it will be understood by those skilled in the art that various changes in form and details may be made therein without departing from the spirit and scope of the present disclosure as defined by the appended claims and their equivalents. Therefore, the scope of the present disclosure should not be limited to the above-described exemplary embodiments but should be determined by not only the appended claims but also the equivalents thereof.

In the above-described embodiments, all steps may be selectively performed or part of the steps and may be omitted. In each embodiment, the steps are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

Meanwhile, the exemplary embodiments of the present disclosure have been described in the drawings and specification. Although specific terminologies are used here, those are only to explain the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein.

What is claimed is:

1. A storage device comprising:
a memory device including a plurality of physical positions; and
a memory controller configured to perform a plurality of firmware operations on at least one physical position among the plurality of physical positions, store position information representing a physical position at which each of the plurality of firmware operations is performed, determine a target physical position at which a firmware operation is successively performed from among the plurality of physical positions based on the position information, and perform the firmware operation at only the target physical position among the plurality of physical positions for a predetermined time period.

2. The storage device of claim 1, wherein the firmware operation occurs according to a physical characteristic corresponding to each of the plurality of physical positions in an operation of the memory device.

3. The storage device of claim 1, wherein, at the target physical position, a number of times the firmware operation is successively performed exceeds a predetermined number of times.

4. The storage device of claim 3, wherein the predetermined number of times decreases as a lifetime of the memory device reduces.

5. The storage device of claim 1, wherein the memory controller omits the firmware operation at the physical positions among the plurality of physical positions other than the target physical position for the predetermined time period.

6. The storage device of claim 1, wherein the memory controller performs the firmware operation on at least one physical position that satisfies an occurrence condition of the firmware operation after the predetermined time period elapses.

7. The storage device of claim 6, wherein the memory controller re-determines the target physical position, based on a firmware operation performed after the predetermined time period elapses.

8. The storage device of claim 1, wherein the predetermined time period decreases as a lifetime of the memory device reduces.

9. A storage device comprising:
a memory device including a plurality of physical positions; and
a memory controller configured to perform a plurality of firmware operations on at least one physical position from among the plurality of physical positions, store position information representing a physical position at which each of the plurality of firmware operations is performed, count a number of times each of the plurality of firmware operations is performed, and determine a target physical position at which a firmware operation is to be performed from among the plurality of physical positions based on the position information, when a number of times the firmware operation is performed reaches a predetermined number of times.

10. The storage device of claim 9, wherein, when the number of times the firmware operation is performed reaches the predetermined number of times, the memory controller determines, as the target physical position, the physical position at which each of the plurality of firmware operations is performed.

11. The storage device of claim 9, wherein, when the number of times the firmware operation is performed does not reach the predetermined number of times, the memory controller performs the firmware operation on at least one physical position satisfying an occurrence condition of the firmware operation among the plurality of physical positions.

12. The storage device of claim 11, wherein the predetermined number of times decreases as a lifetime of the memory device reduces.

13. The storage device of claim 11, wherein the memory controller performs the firmware operation at only the target physical position from among the plurality of physical positions for a predetermined amount of time.

14. The storage device of claim 13, wherein the memory controller omits the firmware operation at the other physical positions except for the target physical position from among the plurality of physical positions for the predetermined amount of time.

15. A method of operating a storage device, the method comprising:
performing a plurality of firmware operations on a memory device;
counting a number of times each of the plurality of firmware operations is performed;
storing position information representing at least one physical position at which each of the plurality of firmware operations is performed from among a plurality of physical positions included in the memory device; and
determining a target physical position at which each of the plurality of firmware operations is to be performed from among the plurality of physical positions based on the number of times each of the plurality of firmware operations is performed and the position information.

16. The method of claim 15, wherein, in the determining of the target physical position, a physical position at which any one firmware operation from among the plurality of firmware operations is successively performed a first number of times or more is determined as the target physical position at which the one firmware operation is to be performed.

17. The method of claim 15, wherein, in the determining of the target physical position, at least one physical position from among the plurality of physical positions at which any one firmware operation from among the plurality of firmware operations is performed is determined as the target physical position if a number of times the one firmware operation is performed reaches a second number of times.

18. The method of claim 15, further comprising:
performing any one firmware operation from among the plurality of firmware operations at only the target physical position corresponding to the one firmware operation for a predetermined time period; and
omitting the one firmware operation at the other physical positions except the target physical position from among the plurality of physical positions for the predetermined time period.
